(19) United States
(12) Patent Application Publication
(10) Pub. No.: US 2026/0342241 A1
(43) Pub. Date: Oct. 29, 2026

(54) BIDIRECTIONAL AC-DC CONVERTER, CONVERTER SYSTEM AND OPERATING METHOD THEREOF

(71) Applicant: DELTA ELECTRONICS, INC., Taoyuan City (TW)

(72) Inventors: Temir SAKAVOV, Taoyuan City (TW); Sheng-Hua LI, Taoyuan City (TW)

(21) Appl. No.: 19/192,355

(22) Filed: Apr. 29, 2025

(51) Int. Cl. H02M 7/797

(52) U.S. Cl. CPC H02M 7/797

(57) ABSTRACT

A bidirectional AC-DC converter. The bidirectional AC-DC converter comprises multiple inductors coupled to multiple power sources respectively; a rectifier circuit comprising multiple first switches and coupled to the inductors; a converter circuit comprising multiple second switches and coupled to the rectifier circuit; and a first controller configured to provide multiple first control signals and multiple second control signals to control the first switches and the second switches respectively; wherein the power sources is configured to provide multiple phase voltage signals and multiple current signals to the rectifier circuit, and when converting the current signals from DC form to AC form during a discharge mode, the first controller provides the first control signals and the second control signals according to the phase voltage signals, the current signals, and a reference phase parameter.

### BACKGROUND

### Technical Field

The present disclosure relates to a converter system. More particularly, the present disclosure relates to a bidirectional AC-DC converter, converter system, and operating method thereof.

### Description of Related Art

A converter circuit is configured to convert an Alternating Circuit (AC) voltage signal to a Direct Circuit (DC) voltage signal. When a converter circuit is applied to charge a load, the converter circuit with a rectifier is configured to convert an input alternating current signal to an output direct current signal. The control cycle of switches in the converter circuit is based on a voltage level of an output voltage signal. The period of the control cycle is determined according to the power source and the type of the load, when the converter circuit is operated to charge the load.

### SUMMARY

The present disclosure provides a bidirectional AC-DC converter. The bidirectional AC-DC converter comprises a plurality of inductors coupled to a plurality of power sources respectively; a rectifier circuit comprising a plurality of first switches and coupled to the plurality of inductors; a converter circuit comprising a plurality of second switches and coupled to the rectifier circuit; and a first controller configured to provide a plurality of first control signals and a plurality of second control signals to control the plurality of first switches and the plurality of second switches respectively; wherein the plurality of power sources is configured to provide a plurality of phase voltage signals and a plurality of current signals to the rectifier circuit, and when converting the plurality of current signals from DC form to AC form during a discharge mode, the first controller provides the plurality of first control signals and the plurality of second control signals according to the plurality of phase voltage signals, the plurality of current signals, and a reference phase parameter.

The present disclosure provides a method. The method comprises calculating a polarity of a converter system according to a plurality of current signals; calculating a control cycle and a duty ratio of the converter system according to each of the plurality of current signals and a reference phase parameter; and controlling a plurality of switches of the converter system according to each of the polarity, the control cycle and the duty ratio, wherein when the converter system is under a charge mode, performing the following operations: when the polarity is positive, turning on a first switch and a second switch of the plurality of switches, and turning off a third switch and a fourth switch of the plurality of switches, and after each of the first switch and the second switch is turned on, turning off the second switch before the first switch is turned off.

The present disclosure provides a converter system. The converter system comprises a plurality of power sources coupled to a plurality of inductors, respectively, the plurality of power sources configured to provide a plurality of phase voltage signals and a plurality of current signals; a rectifier circuit coupled to the plurality of inductors; a converter circuit comprising a plurality of first switches, a first capacitor and a second capacitor, each of the first capacitor and the second capacitor coupled to the rectifier circuit; and a first controller configured to calculate a plurality of reference current signals, a plurality of domain current signals, and a plurality of domain reference current signals according to the plurality of phase voltage signals, the plurality of current signals, and a reference phase parameter.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a converter system, illustrated in accordance with some embodiments of the present disclosure.

FIG. 2 is a schematic diagram of a controller in the converter system, illustrated in accordance with some embodiments of the present disclosure.

FIG. 3 is a flow diagram of a method of operating the converter system, illustrated in accordance with some embodiments of the present disclosure.

FIG. 4 is a flow diagram of a method of determining a polarity of the converter system by a selector, illustrated in accordance with some embodiments of the present disclosure.

FIG. 5 is a waveform diagram of the reference current signals and the polarity, corresponding to FIG. 4, of the converter system, illustrated in accordance with some embodiments of the present disclosure.

FIG. 6A is a timing diagram of control signals controlling the switches of the converter system, illustrated in accordance with some embodiments of the present disclosure.

FIG. 6B is a timing diagram of control signals controlling the switches of the converter system, illustrated in accordance with some embodiments of the present disclosure.

FIG. 7A is a timing diagram of control signals controlling the switches of the converter system, illustrated in accordance with some embodiments of the present disclosure.

FIG. 7B is a timing diagram of control signals controlling the switches of the converter system, illustrated in accordance with some embodiments of the present disclosure.

FIG. 8 is a table of logic values of the control signals of a rectifier circuit, illustrated in accordance with some embodiments of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

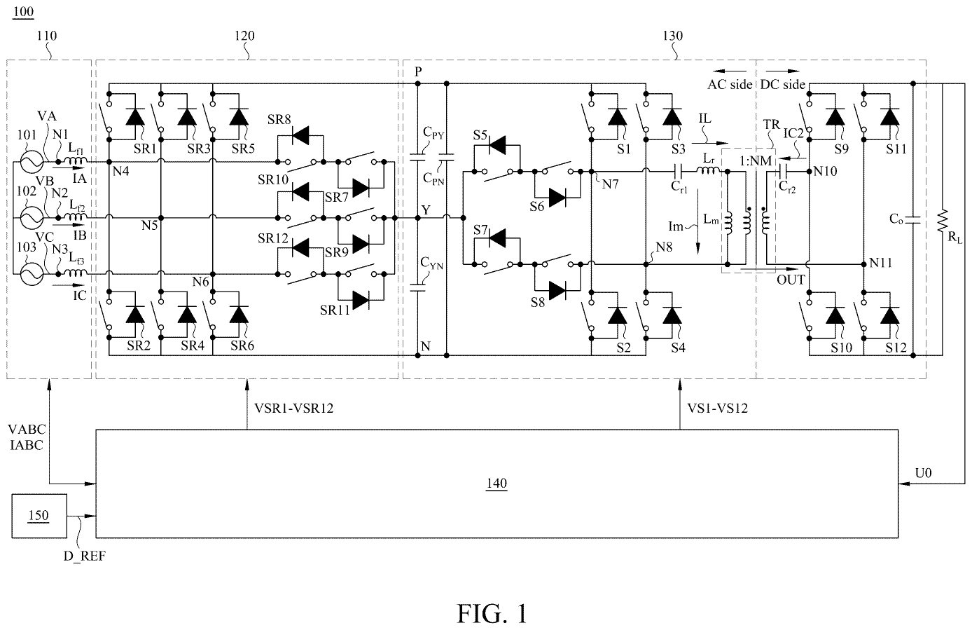

FIG. 1 is a schematic diagram of a converter system 100, illustrated in accordance with some embodiments of the present disclosure. As illustratively shown in FIG. 1, the converter system 100 includes a power circuit 110, a rectifier circuit 120, a converter circuit 130, a controller 140, and an energy system 150. The power circuit 110 includes power sources 101-103 and inductors L_{f1}, L_{f2}, and L_{f3}. The rectifier circuit 120 includes multiple switches SR1-SR12. The converter circuit 130 includes multiple switches S1-S12, a transformer TR, a resistor R_{L}, inductor Lᵣ, inductor Lₘ, capacitors C_{PY}, C_{YN}, C_{PN}, Cᵣ₁, Cᵣ₂, and Co.

In some embodiments, the power circuit 110 is configured to transmit a phase voltage signal VABC and a current signal IABC to the controller 140. In some embodiments, the phase voltage signal VABC includes the phase voltage signals VA, VB, and VC. The phase voltage signals VA, VB, and VC are generated by the power sources 101-103, respectively. The current signal IABC includes the current signals IA, IB, and IC. The controller 140 is configured to receive a reference phase parameter D_REF from the energy system 150. The power controller 140 is further configured to control each of the switches SR1-SR12 of the rectifier circuit 120 and the switches S1-S12 of the converter circuit 130 according to each of the phase voltage signal VABC, the current signal IABC, and the reference phase parameter D_REF. In some embodiments, the converter circuit 130 transmits the load voltage signal U0 to the power controller 140 to adjust the switching sequence and timing of the switches S1-S12 to stabilize an output voltage to a reference voltage level Uref. In some embodiments, the load voltage signal U0 is an output voltage signal of the converter system 100.

As illustratively shown in FIG. 1, a power source 101 is coupled to a terminal of an inductor L_{f1} at a node N1, and is configured to provide a phase voltage signal VA to the rectifier circuit 120. Another terminal of the inductor L_{f1} is coupled to each of the switches SR1 and SR2 at a node N4. A power source 102 is coupled to a terminal of an inductor L_{f2} at a node N2, and is configured to provide a phase voltage signal VB to the rectifier circuit 120. Another terminal of the inductor L_{f2} is coupled to each of the switches SR3 and SR4 at a node N5. A power source 103 is coupled to a terminal of an inductor L_{f3} at a node N3, and is configured to provide a phase voltage signal VC to the rectifier circuit 120. Another terminal of the inductor L_{f3} is coupled to each of the switches SR5 and SR6 at a node N6. In some embodiments, the phase voltage signals VA, VB, and VC are transmitted to the controller 140 at the nodes N1, N2, and N3, respectively. In some embodiments, each of the nodes N1, N2, and N3 is referred to the neutral point of the power circuit.

As illustratively shown in FIG. 1, in the rectifier circuit 120, a first terminal of the switch SR1 is coupled to each of the inductor L_{f1} and a first terminal of the switch SR2 at the node N4. A second terminal of the switch SR1 is coupled to a first terminal of the capacitor C_{PY} at a node P. A second terminal of the switch SR2 is coupled to a first terminal of the capacitor C_{YN} at a node N. A first terminal of the switch SR3 is coupled to each of the inductor L_{f2} and a first terminal of the switch SR4 at the node N5. A second terminal of the switch SR3 is coupled to the first terminal of the capacitor C_{PY} at the node P. A second terminal of the switch SR4 is coupled to the first terminal of the capacitor C_{YN} at a node N. A first terminal of the switch SR5 is coupled to each of the inductor L_{f3} and a first terminal of the switch SR6 at the node N6. A second terminal of the switch SR5 is coupled to the first terminal of the capacitor C_{PY} at the node P. A second terminal of the switch SR6 is coupled to the first terminal of the capacitor C_{YN} at a node N.

In some embodiments, in the rectifier circuit 120, a first terminal of the switch SR8 is coupled to the L_{f1} at the node N4, and a second terminal of the switch SR8 is coupled to a first terminal of the switch SR7. A second terminal of the switch SR7 is coupled to each of a second terminal of the capacitor C_{PY} and a second terminal of the capacitor C_{YN} at a node Y. A first terminal of the switch SR10 is coupled to the L_{f2} at the node N5, and a second terminal of the switch SR10 is coupled to a first terminal of the switch SR9. A second terminal of the switch SR9 is coupled to each of the second terminal of the capacitor C_{PY} and the second terminal of the capacitor C_{YN} at a node Y. A first terminal of the switch SR12 is coupled to the L_{f3} at the node N6, and a second terminal of the switch SR12 is coupled to a first terminal of the switch SR11. A second terminal of the switch SR11 is coupled to each of the second terminal of the capacitor C_{PY} and the second terminal of the capacitor C_{YN} at a node Y.

As illustratively shown in FIG. 1, in the converter circuit 130, a first terminal of the switch S5 is coupled to the rectifier circuit 120 at the node Y. A second terminal of the switch S5 is coupled to a first terminal of the switch S6, and a second terminal of the switch S6 is coupled to a first terminal of the capacitor Cᵣ₁ at a node N7. A first terminal of the switch S7 is coupled to the rectifier circuit 120 at the node Y. A second terminal of the switch S7 is coupled to a first terminal of the switch S8, and a second terminal of the switch S8 is coupled to a first terminal of the inductor Lₘ at a node N8. A first terminal of the switch S1 is coupled to a first terminal of the switch S3 at the node P, and a second terminal of the switch S1 is coupled to a first terminal of the switch S2 at the node N7. A second terminal of the switch S3 is coupled to a first terminal of the switch S4 at the node N8. A second terminal of the switch S4 is coupled to a second terminal of the switch S2 at the node N.

In some embodiments, in the converter circuit 130, a second terminal of the capacitor Cᵣ₁ is coupled to a terminal of the inductor Lᵣ. The other terminal of the inductor Lᵣ is coupled to a dotted terminal of the transformer TR and a second terminal of the inductor Lₘ. The first terminal of the inductor Lₘ is further coupled to a non-dotted terminal of the transformer TR. The dotted terminal of the transformer TR is coupled to a terminal of a capacitor Cᵣ₂, and the other terminal of the capacitor Cᵣ₂ is coupled to each of a first terminal of the switch S9 and a first terminal of the switch S10 at a node N10. A second terminal of the switch S9 is coupled to each of a first terminal of the switch S11 and a first terminal of the capacitor Co. A second terminal of the switch S11 is coupled to each of a first terminal of the switch S12 and the non-dotted terminal of the transformer TR at a node N11. A second terminal of the switch S12 is coupled to each of a second terminal of the switch S10 and a second terminal of the capacitor Co. The first terminal of the capacitor Co is further coupled to a first terminal of the resistor R_{L}, and the second terminal of the capacitor Co is further coupled to a second terminal of the resistor R_{L}.

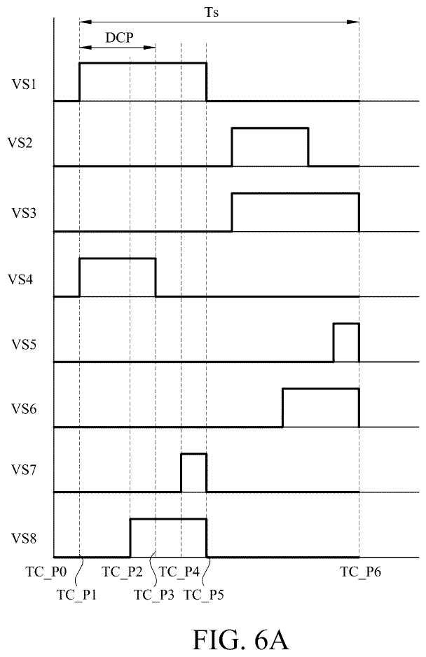

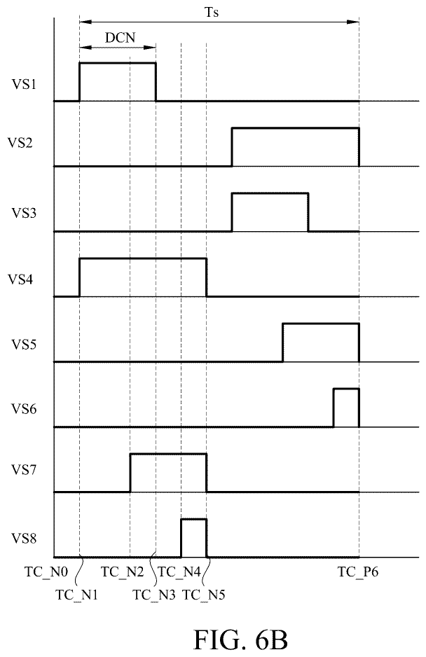

In some embodiments, control terminals of the switches SR1-SR12 are configured to receive multiple control signals VSR1-VSR12 from a selector 131 in the controller 140, respectively. Accordingly, each of the switches SR1-SR12 is controlled by the selector 131. Control terminals of the switches S1-S12 are configured to receive multiple control signals VS1-VS12 from a selector 136 in the controller 140, respectively. Accordingly, each of the switches S1-S12 is controlled by the selector 136. Further details regarding the control of each of the switches SR1-SR12 and S1-S12 is discussed in FIG. 6A to FIG. 8 and corresponding paragraph of the present disclosure.

In some embodiments, the transformer TR includes an AC side coil and a DC side coil. A ratio of a turns of the AC side coil to a turns of the DC side coil is 1:NM. Wherein NM is a positive rational number. The resultant ratio of the transformer TR is to be approximated by natural numbers of turns in the given embodiment. The inductor Lₘ represents the magnetic inductance of the transformer TR, and the inductor Lᵣ may be the leakage inductance of the transformer TR or a separate inductor.

In some embodiments, the resistor R_{L} represents a resistance of a load, and the load can be implemented by an output device. For example, the output device can be the battery unit of the automotive vehicle. In some embodiments, the reference voltage level Uref is determined by the controller 140 according to various type of load, such as an automotive vehicle battery unit. Alternatively stated, the reference voltage level Uref corresponds to the voltage required by the load. When the voltage level of the load voltage signal U0 is different from the reference voltage level Uref, the controller 140 adjusts the voltage level of the load voltage signal U0 to the reference voltage level Uref.

In some embodiments, the energy system 150 provides the reference phase parameter D_REF to the controller 140 according to requirements of the power grid. The reference phase parameter D_REF is provided to the controller 140 which is configured to adjust the phase displacement of consumed currents of the current signal IABC and of the phase voltage signal VABC generated by the power circuit 110. Control of the phase allows the power circuit 110 to change the portions of reactive and active power consumption of the converter system 100 by the displacement of the current signal IABC from the phase voltage signal VABC. Alternatively stated, the reference phase parameter D_REF sets a reference point for the phase shift between grid voltage and consumed current, which in turn changes the active/reactive power consumption.

In some embodiments, each of the power sources 101-103 is implemented by Alternating Current (AC) power source. The current level of a current signal having the AC form is alternating with respect to time. In some embodiments, each of the switches SR1-SR12 includes an Insulated Gate Bipolar Transistor (IGBT) connected in parallel with a diode, or is implemented by an Insulated Gate Bipolar Transistor (IGBT) co-packaged with freewheeling diode. Each of the switches S1-S12 is implemented by a Silicon Carbide (SiC) Metal Oxide Semiconductor Field-Effect Transistor (MOSFET). The structure of a SiC MOSFET includes a body diode. In some embodiments, when a control terminal of the SiC MOSFET has the voltage level VL, the SiC MOSFET is turned off. When a control terminal of the SiC MOSFET has the voltage level VH, the SiC MOSFET is turned on. In some embodiments, when a control terminal of the IGBT has the voltage level VL, the IGBT is turned off. When a control terminal of the IGBT has the voltage level VH, the IGBT is turned on. In some embodiments, the voltage level VH is higher than the voltage level VL.

In some embodiments, when the converter system 100 is operating, each of the phase voltage signal VABC of power circuit 110 is provided to the rectifier 120. The rectifier 120 is configured to convert the phase voltage signal VABC having the AC form to the Direct Current (DC) form. The rectifier 120 commutates the phase voltage signal VABC generated from the power circuit 110 on the capacitors C_{PY}, C_{YN}, and C_{PN} at the nodes P, Y and N. Then, each of the capacitors C_{PY}, C_{YN} and C_{PN}, and the power circuit 110 commutated on these capacitors provides DC voltages that are further commutated by the converter 130 on the transformer TR. The provided DC voltages are rectified by switches S9-S12, and generate the output voltage signal U0. The output voltage signal U0 in turn generates an output current signal IOUT at the load. This output current signal IOUT is reflected backwards forming currents at the resonant circuit. Reflected backwards current is shaped with duty modulation forming the current signal IABC while the amplitude of the current signal IABC depends on the size of the load. Each of the output current signal IOUT and the load voltage signal U0 is transmitted to the capacitor Co and the resistor R_{L}. Alternatively stated, each of the output current signal IOUT and the load voltage signal U0 is configured to supply power to the load. Accordingly, the converter system 100 can be referred to as a bidirectional AC-DC converter. In some embodiments, the power is determined based on the load voltage signal U0 and the resistance of the resistor R_{L} which follows the Ohm's Law of electric circuits. In some embodiments, the resonant circuit refers to a part of the converter circuit 130 including the switches S1-S8.

In some embodiments, a rectified voltage is formed by switching between the phase voltage signals VA, VB and VC, and the switching of switches SR1-SR12, which produces noise. The noise is being filtered by the capacitors C_{PY}, C_{PN}, and C_{YN}.

In some approaches, a converter system is able to operate under both charge and discharge mode. To achieve this, diodes of the converter system are substituted with semiconductor switches, and specific modulation modes are applied. However, when operating under high voltage variation, the converter system would fail to provide voltage boost in discharge mode due to usage of LC or LLC resonant circuits. Although the discharge mode was proposed in previous approaches, the modulation scheme was not effectively possible to operate with wide power factor adjustment.

Compared to above approaches, in some embodiments of the present disclosure, the controller 140 of the converter system 100 calculates the switch frequency FSW and the duty ratio DPN according to each of the phase voltage signal VABC, the current signal IABC, and the reference phase parameter D_REF. Each of the switches S1-S12 is controlled according the switch frequency FSW and the duty ratio DPN. Accordingly, the converter system 100 can be operated in both the charge mode and the discharge mode based on different switch frequency, duty ratio and modulation scheme which is applicable to wide power factor adjustment.

In some embodiments, the discharge mode is referred to as a DC to AC mode, in response to the current signal IABC converting from the DC form to the AC form. The charge mode is referred to as an AC to DC mode, in response to the current signal IABC converting from the AC form to the DC form.

In some embodiments, the duty ratio DPN is a period in which the switches S1-S12 are turned on or turned off. Specifically, the duty ratio DPN is a period of commutating either voltage of capacitor CPN or one of the capacitors C_{PY} or C_{YN} on the transformer TR. The duty ratio DPN can modulate the voltage levels applied to the transformer TR. When the duty ratio DPN is higher, a voltage level of an output voltage signal generated by the transformer TR is higher. In some embodiments, a period of which each of the switches S1-S12 has turned on and turned off is a control cycle Ts. The control cycle Ts is a reciprocal of the switch frequency FSW.

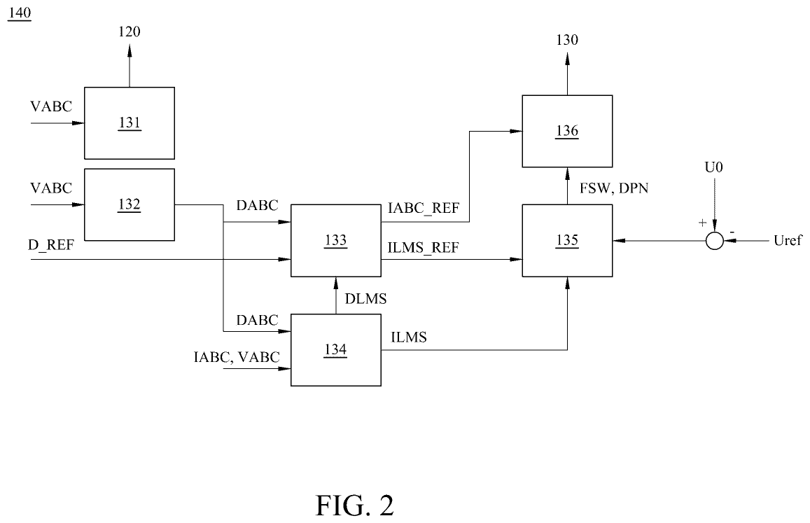

FIG. 2 is a schematic diagram of the controller 140 in the converter system 100, illustrated in accordance with some embodiments of the present disclosure. As illustratively shown in FIG. 2, the controller 140 includes a selector 131, a phase-locked loop 132, a reference calculator 133, a mapping calculator 134, a voltage/current controller 135, and a selector 136.

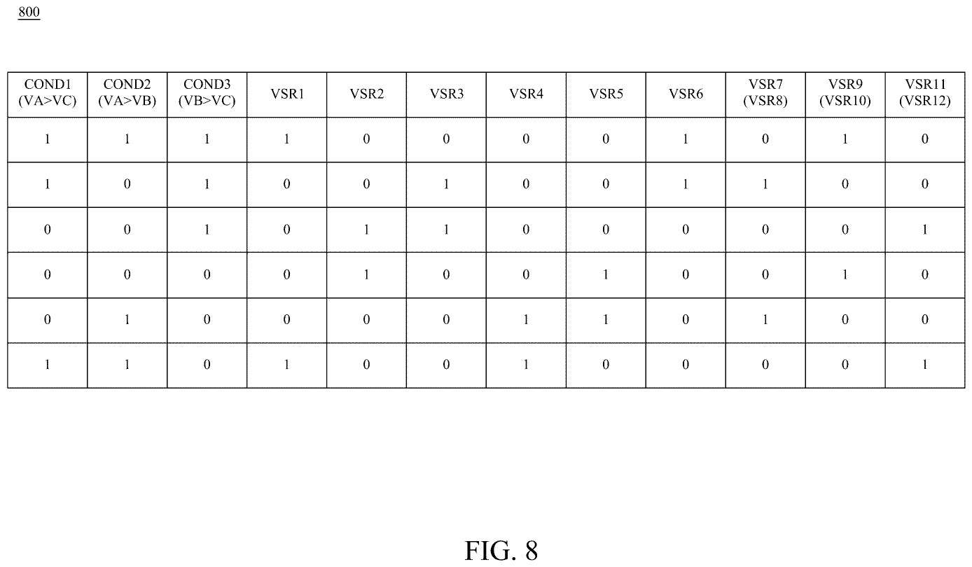

Referring to FIG. 1 and FIG. 2, the selector 131 is configured to receive the phase voltage signal VABC from the power sources 101-103, and control each of the switches SR1-SR12 according to the phase voltage signal VABC. Further details regarding the control of each of the switches SR1-SR12 is discussed in FIG. 8 and corresponding paragraph of the present disclosure.

As illustratively shown in FIG. 2, the phase-locked loop 132 is configured to receive the phase voltage signal VABC from the power sources 101-103 in FIG. 1 and generate a voltage phase parameter DABC. The phase-locked loop 132 further transmits the voltage phase parameter DABC to each of the reference calculator 133 and the mapping calculator 134.

In some embodiments, the mapping calculator 134 is configured to generate a domain phase parameter DLMS according to the voltage phase parameter DABC, and transmit the domain phase parameter DLMS to the reference calculator 133. The mapping calculator 134 is further configured to receive each of the phase voltage signal VABC and the current signal IABC from the power sources 101-103 in FIG. 1 and generate a domain current signal ILMS. The mapping calculator 134 transmits the domain current signal ILMS to the voltage/current controller 135.

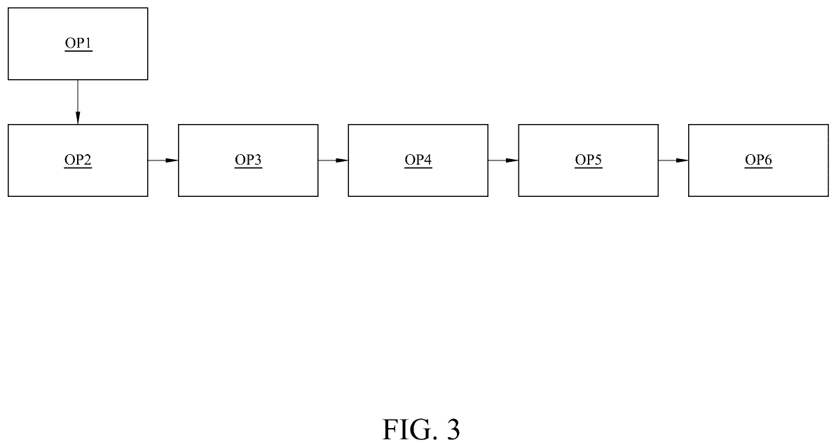

In some embodiments, the reference calculator 133 is configured to receive each of the domain phase parameter DLMS and the reference phase parameter D_REF to perform a reference calculation. The reference calculator 133 generates each of a reference current signal IABC_REF and a reference domain current signal ILMS_REF after the reference calculation and transmits the reference current signal IABC_REF and the reference domain current signal ILMS_REF to the selector 136 and the voltage current controller 135, respectively. In some embodiments, the voltage current controller 135 is configured to generate each of a switch frequency FSW and a duty ratio DPN according to each of the domain current signal ILMS and the reference domain current signal ILMS_REF. Further details regarding the generation of the domain phase parameter DLMS, the domain current ILMS, and the reference domain current signal ILMS_REF are discussed in FIG. 3 and corresponding paragraph of the present disclosure.

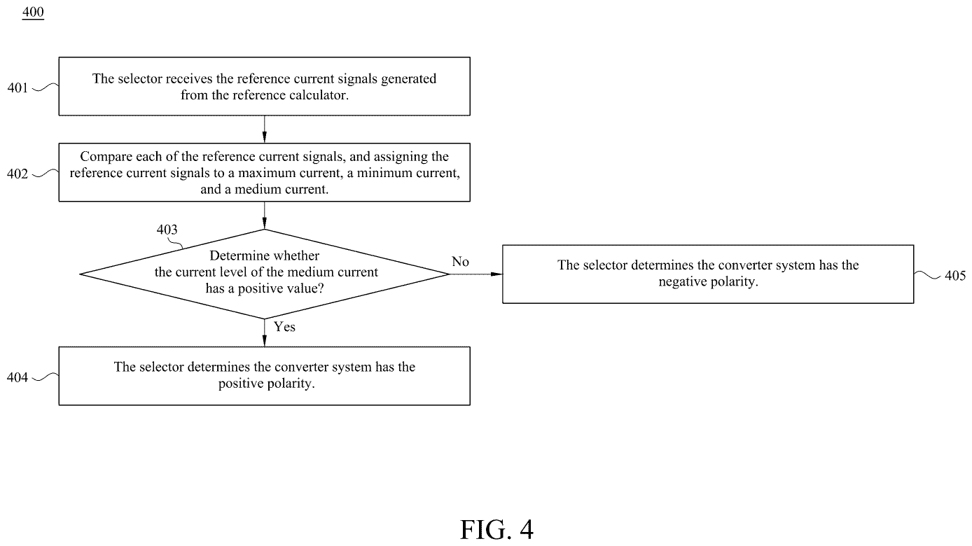

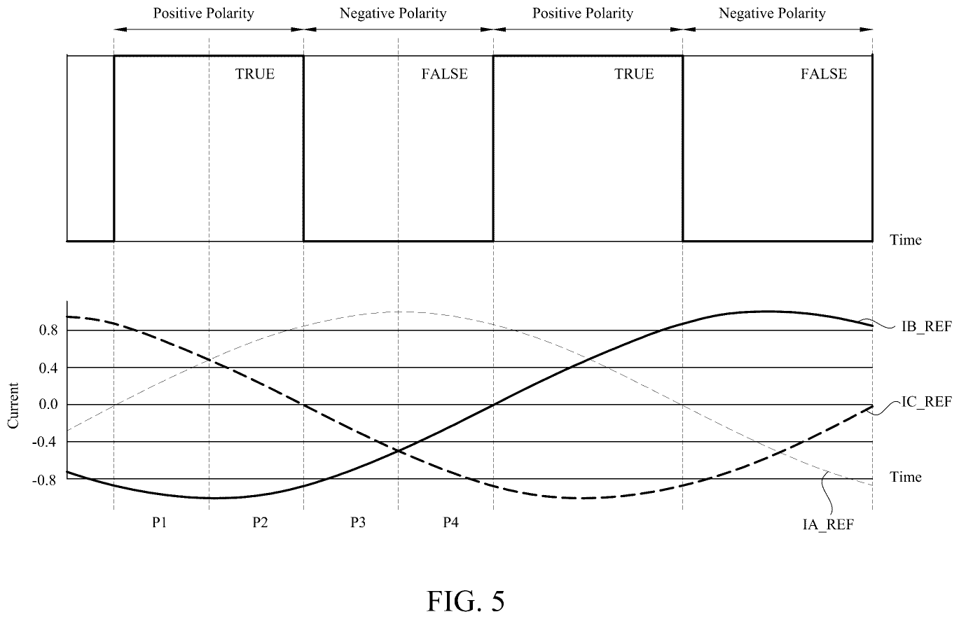

In some embodiments, the selector 136 is configured to generate the control signals VS1-VS12 according each of the switch frequency FSW and the duty ratio DPN. Furthermore, the selector 136 determines a polarity POL (not shown in FIG. 2) of the converter system 100 according to the reference current signal IABC_REF. Then, the selector 136 is further configured to control the switches S1-S12 by the control signals VS1-VS12, respectively, based on the polarity POL. Further details regarding the determination of the polarity POL are discussed in FIG. 4 and FIG. 5 and corresponding paragraph of the present disclosure.

In some embodiments, the voltage phase parameter DABC includes voltage phases DA, DB, and DC corresponding to the phase voltage signals VA, VB, and VC, respectively. The reference current signal IABC_REF includes reference current signals IA_REF, IB_REF, and IC_REF corresponding to the current signals IA, IB, and IC, respectively.

In some embodiments, the domain phase parameter DLMS includes domain phase parameters DL, DM, and DS. The domain current signal ILMS includes domain current signals IL, IM, and IS. The reference domain signal ILMS_REF includes reference domain signals IL_REF, IM_REF, and IS_REF.

FIG. 3 is a flow diagram of a method 300 of operating the converter system 100, illustrated in accordance with some embodiments of the present disclosure. As illustratively shown in FIG. 3, the method 300 includes operations OP1-OP6.

Referring to FIG. 2 and FIG. 3, the operation OP1 corresponds to the phase-locked loop 131. The operation OP2 corresponds to the mapping calculator 134. The operation OP3 corresponds to the reference calculator 133. The operation OP4 corresponds to the voltage/current controller 135. The operations OP5 and OP6 correspond to the selector 136.

At the operation OP1, the phase-locked loop 132 performs a phase lock operation to the phase voltage signal VABC to determine the voltage phase parameter DABC of the phase voltage signals VABC. Specifically, the phase-locked loop 132 is configured to generate the voltage phase parameter DABC that corresponds to the phase of the phase voltage signal VABC. The phase-locked loop 132 further transmits the voltage phase parameter DABC to each of the reference calculator 133 and the mapping calculator 134. The converter system 100 performs the operation OP2 after the operation OP1 is performed.

At the operation OP2, the mapping calculator 134 modifies the domain of the voltage phase parameter DABC and the current signal IABC to generate the domain phase parameter DLMS and the domain current signal ILMS, respectively, according to the phase voltage signal VABC. The mapping calculator 134 transmits the domain phase parameter DLMS and the domain current signal ILMS to the reference calculate 133 and the voltage/current controller 135, respectively.

Specifically, the mapping calculator 134 receive each of the phase voltage signal VA, VB and VC, the current signal IA, IB and IC, and voltage phases DA, DB and DC, and measures absolute values |VA|, |VB|, and |VC| of the phase voltage signal VA, VB and VC, respectively.

Then, the mapping calculator 134 assigns the absolute values |VA|, |VB|, and |VC| to a minimum value, a medium value, and a maximum value, respectively. For example, when the absolute values |VA|, |VB|, and |VC| has voltage levels 20 volt, 15 volt, and 10 volt, respectively, the absolute value |VA| is assigned to the maximum value, the absolute value |VB|is assigned to the medium value, and the absolute value |VC| is assigned to the minimum value.

After each of the absolute values |VA|, |VB|, and |VC| is assigned to the minimum value, the medium value, and the maximum value, absolute values |IA|, |IB|, and |IC| respectively correspond to the current signals IA, IB and IC are transformed correspondingly to the domain current signals IL, IM, IS, respectively. The voltage phases DA, DB and DC are transformed correspondingly to the domain phases DL, DM, DS, respectively. Alternatively stated, the current signal IABC is mapped to the domain current signal ILMS, and the voltage phase parameter DABC is mapped to the domain phase parameter DLMS.

For example, when the absolute value |VA| is assigned to the maximum value, the absolute value |VB| is assigned to the medium value, and the absolute value |VC| is assigned to the minimum value, the current signal IA is transformed to the domain current signal IL, the current signal IB is transformed to the domain current signal IM, and the current signal IC is transformed to the domain current signal IS. Similarly, the voltage phase parameter DA is transformed to the domain phase parameter DL. The voltage phase parameter DB is transformed to the domain phase parameter DM. The voltage phase parameter DC is transformed to the domain phase parameter DS.

After the domain current signal ILMS and the voltage phase parameter DABC are generated, the mapping calculator 134 transmits the domain phase parameter DLMS and the domain current signal ILMS to the reference calculator 133 and the voltage/current controller 135, respectively. The converter system 100 performs the operation OP3 after the operation OP2 is performed.

At the operation OP3, the reference calculator 133 receives each of the reference phase parameter D_REF, the voltage phase parameter DABC and the domain phase parameter DLMS, and calculates the reference current signal IABC_REF and the reference domain current signal ILMS_REF. After each of the reference current signal IABC_REF and the reference domain current signal ILMS_REF is calculated, the reference calculator 133 transmits the reference current signal IABC_REF and the reference domain current signal ILMS_REF to the selector 136 and voltage/current controller 135, respectively.

Specifically, the reference calculator 133 calculates sine values to the voltage phases DA, DB and DC with the reference phase parameter D_REF to generate the reference current signals IA_REF, IB_REF and IC_REF, respectively. The calculation of the reference current signals IA_REF, IB_REF and IC_REF is shown as following equations.

IA_REF=sin (DA+D_REF)

IB_REF=sin (DB+D_REF)

IC_REF=sin (DC+D_REF)

Additionally, the reference calculator 133 calculates sine values the absolute values to the domain phases DL, DM and DL with the reference phase parameter D_REF to generate the reference domain current signals IL_REF, IM_REF and IS_REF, respectively. The calculation of the reference domain current signals IL_REF, IM_REF and IS_REF is shown as following equations.

IL_REF=|(|sin (DL+D_REF))

ℑ_REF=|(|sin (DM+D_REF))

IS_REF=|(|sin (DS+D_REF))

In some embodiments, each of the voltage phases DA, DB and DC, the domain phases DL, DM and DS, and the reference phase parameter D_REF is represented in degree. For example, when the reference phase parameter D_REF is 30 degree and the voltage phase parameter DA is 45 degrees, the reference current signal IA_REF has the value of sin75°. In some embodiments, the reference phase parameter D_REF can be implemented by 0 degree, 15 degrees, 30 degrees, −15 degrees, −30 degrees, or any other degrees.

Then, the reference calculator 133 transmits each of the reference current signals IA_REF, IB_REF and IC_REF, and the reference domain current signals IL_REF, IM_REF and IS_REF to the selector 136 and voltage/current controller 135, respectively. The converter system 100 performs the operation OP4 after the operation OP3 is performed.

At the operation OP4, the voltage/current controller 135 calculates the switch frequency FSW and the duty ratio DPN according to each of the domain current signal ILMS and the reference domain current signal ILMS_REF.

Specifically, the voltage/current controller 135 adjusts the domain current signals IL, IM and IS according to the reference domain current signals IL_REF, IM_REF, and IS_REF, respectively. Then, the voltage/current controller 135 generates the switch frequency FSW and the duty ratio DPN according to the periods of the domain current signal ILMS and the reference domain current signal ILMS_REF. After the switch frequency FSW and the duty ratio DPN are generated, the voltage/current controller 135 transmits the switch frequency FSW and the duty ratio DPN to the selector 136. Specifically, the switch frequency FSW is controlling the voltage level of the output voltage signal U0, and the duty ratio DPN is controlling the current signal IABC, which is the power factor of the converter system 100, and displacement relative to the phase voltage signal VABC. The converter system 100 performs the operation OP5 after the operation OP4 is performed.

At the operation OP5, the selector 136 receives the reference current signal IABC_REF, and is configured to determine the polarity POL of the reference current signal IABC_REF, and select an operating mode of the converter system 100.

Specifically, the selector 136 is configured to determine whether the polarity POL is positive or negative. In addition, the selector 136 is further configured to select the operating mode of the converter system 100. Further details regarding the determination of the polarity POL and the selection of the operating mode is discussed in FIG. 4 to FIG. 7B and the corresponding paragraph of the present disclosure. The converter system 100 performs the operation OP6 after the operation OP5 is performed.

At the operation OP6, the selector 136 is configured to generate the control signals VS1-VS12 to control the switches S1-S12 according to the switch frequency FSW determined by controller 135, the duty ratio DPN, the operating mode, and the polarity POL. Specifically, the selector 136 is configured to select positive or negative control sequence of the switches S1-S12 under both charge mode and discharge mode. In some embodiments, the positive and negative control corresponds to the positive and negative polarity.

In some embodiments, when the converter system 100 is operated under the charge mode, each of the voltage signals VS9-VS12 has the voltage level VL, such that each of the switches S9-S12 remains turned off. The selector 136 is configured to control the switches S1-S8 according to each of the switch frequency FSW, the duty ratio DPN, and the polarity POL.

In some embodiments, when the converter system 100 is operated under the discharge mode, each of the voltage signals VS1-VS4 has the voltage level VL, such that each of the switches S1-S4 remains turned off. The selector 136 is configured to control the switches S5-S12 according to each of the switch frequency FSW, the duty ratio DPN, and the polarity POL.

FIG. 4 is a flow diagram of a method 400 of determining the polarity POL of the converter system 100 by the selector 136, illustrated in accordance with some embodiments of the present disclosure. As illustratively shown in FIG. 4, the method 400 includes operations 401-405.

At the operation 401, the selector 136 receives the reference current signal IABC_REF generated from the reference calculator 133. Specifically, the selector 136 receives each of the reference current signals IA_REF, IB_REF, and IC_REF calculated by the reference calculator 133. The selector 136 performs the operation 402 after the operation 401 is performed.

At the operation 402, the selector 136 compares each of the reference current signals IA_REF, IB_REF, and IC_REF, and assigning the reference current signals IA_REF, IB_REF, and IC_REF to a maximum current, a minimum current, and a medium current.

Specifically, the selector 136 compares the current levels of each of the reference current signals IA_REF, IB_REF, and IC_REF. Then, the selector 136 assigns one of the reference current signals IA_REF, IB_REF, and IC_REF having a highest current level to the maximum current. The selector 136 assigns one of the reference current signals IA_REF, IB_REF, and IC_REF having an intermediate current level to the medium current. The selector 136 assigns one of the reference current signals IA_REF, IB_REF, and IC_REF having a lowest current level to the medium current.

For example, when the reference current signals IA_REF, IB_REF, and IC_REF have the current levels 1.0 ampere, 0.8 ampere, and 0.5 ampere, respectively, the reference current signal IA_REF is assigned to the maximum current. Similarly, the reference current signal IB_REF is assigned to the medium current, and the reference current signal IC_REF is assigned to the minimum current. The selector 136 performs the operation 403 after the operation 402 is performed.

At the operation 403, the selector 136 determines whether the current level of the medium current has a positive value.

Specifically, when the reference current signal IB_REF is assigned to the medium current, the selector 136 determines whether the current level of the reference current signal IB_REF has a positive value. When the current level of the medium current has a positive value, the selector 136 performs the operation 404 after the operation 403 is performed. When the current level of the medium current has a negative value, the selector 136 performs the operation 405 after the operation 403 is performed.

For example, when the reference current signal IB_REF has a current level 0.8 ampere, the selector 136 performs the operation 404 after the operation 403 is performed. When the reference current signal IB_REF has a current level −0.8 ampere, the selector 136 performs the operation 405 after the operation 403 is performed.

At the operation 404, when the current level of the medium current has a positive value, the selector determines the converter system 100 has the positive polarity. For example, when the current level of the medium current is 0.8 ampere, the converter system 100 has the positive polarity.

At the operation 405, when the current level of the medium current has a negative value, the selector determines the converter system 100 has the negative polarity. For example, when the current level of the medium current is −0.8 ampere, the converter system 100 has the negative polarity.

In some embodiments, the current levels of each of the reference current signals IA_REF, IB_REF, and IC_REF changes with respect to time. Accordingly, the selector 136 repeats the operation 401 to the operation 403 after the method 400 is completed.

FIG. 5 is a waveform diagram of the reference current signals IA_REF, IB_REF and IC_REF, and the polarity POL, corresponding to FIG. 4, of the converter system 100, illustrated in accordance with some embodiments of the present disclosure. As shown in FIG. 5, FIG. 5 illustrates the variations of the reference current signals IA_REF, IB_REF and IC_REF, and the polarity POL during periods P1-P4.

During the period P1, the reference current signal IC_REF has the highest current level. The reference current signal IA_REF has the intermediate current level. The reference current signal IB_REF has the lowest current level. For example, as shown in FIG. 5 the reference current signal IC_REF has a current level approximately ranging from 0.6 ampere to 0.8 ampere. The reference current signal IB_REF has a current level lower than −0.8 ampere. The reference current signal IA_REF has a current level approximately ranging from 0 ampere to 0.4 ampere.

At this moment, the reference current signal IA_REF is the medium current. The current level of the reference current signal IA_REF has a positive value, such that the polarity POL is logical value of TRUE. In response to the polarity POL having the logical value of TRUE, the selector 136 determines the converter system 100 has the positive polarity.

During the period P2, the reference current signal IA_REF has the highest current level. The reference current signal IC_REF has the intermediate current level. The reference current signal IB_REF has the lowest current level. For example, as shown in FIG. 5 the reference current signal IA_REF has a current level approximately ranging from 0.4 ampere to 0.8 ampere. The reference current signal IC_REF has a current level approximately ranging from 0 ampere to 0.4 ampere. The reference current signal IB_REF has a current level lower than −0.8 ampere.

At this moment, the reference current signal IC_REF is the medium current. The current level of the reference current signal IC_REF has a positive value, such that the polarity POL has a logical value of TRUE. In response to the polarity POL having the logical value of TRUE, the selector 136 determines the converter system 100 has the positive polarity.

During the period P3, the reference current signal IA_REF has the highest current level. The reference current signal IC_REF has the intermediate current level. The reference current signal IB_REF has the lowest current level. For example, as shown in FIG. 5 the reference current signal IA_REF has a current level higher than 0.8 ampere. The reference current signal IC_REF has a current level approximately ranging from −0.4 ampere to 0 ampere. The reference current signal IB_REF has a current level approximately ranging from −0.8 ampere to −0.4 ampere.

At this moment, the reference current signal IC_REF is the medium current. The current level of the reference current signal IC_REF has a negative value, such that the polarity POL has a logical value of FALSE. In response to the polarity POL having the logical value of FALSE, the selector 136 determines the converter system 100 has the negative polarity.

During the period P4, the reference current signal IA_REF has the highest current level. The reference current signal IB_REF has the intermediate current level. The reference current signal IC_REF has the lowest current level. For example, as shown in FIG. 5 the reference current signal IA_REF has a current level higher than 0.8 ampere. The reference current signal IB_REF has a current level approximately ranging from −0.4 ampere to 0 ampere. The reference current signal IC_REF has a current level approximately ranging from −0.8 ampere to −0.4 ampere.

At this moment, the reference current signal IB_REF is the medium current. The current level of the reference current signal IB_REF has a negative value, such that the polarity POL has a logical value of FALSE. In response to the polarity POL having the logical value of FALSE, the selector 136 determines the converter system 100 has the negative polarity.

In some embodiments, the reference current signals IA_REF, IB_REF and IC_REF changes periodically. As a result, the polarity POL of the converter system 100 after the period P4 is similar to the periods P1-P4. The polarity POL after the period P4 is not repeated herein for simplicity.

FIG. 6A is a timing diagram of the control signals VS1-VS8 controlling the switches S1-S8 of the converter system 100, illustrated in accordance with some embodiments of the present disclosure. FIG. 6A illustrates the variations of the voltage signals VS1-VS8 from time TC_P0 to time TC_P6. In some embodiments, FIG. 6A corresponds to the control of the switches S1-S8, when the polarity POL is positive and the converter system 100 is operated under the charge mode.

Referring to FIG. 6A and FIG. 1, when the converter system 100 is operated under the charge mode, the capacitors C_{PY}, C_{YN}, and C_{PN} are configured to provide the voltage filter that filters the commutation of the grid voltages, such as the rectified voltage, produced by the power circuit 110.

During a period between time TC_P0 and TC_P1, each of the control signals VS1-VS8 has the voltage level VL, such that each of the switch S1-S8 is turned off. A magnetizing current signal Im of the inductor Lₘ is flowing through the inductor Lₘ from the inductor Lᵣ, when one of the capacitors C_{PY}, C_{YN}, and C_{PN} was commutated. In this case, the current signal Im of the inductor Lₘ is negative forcing the body diodes S1, S4 to conduct. This allows for discharging of parasitic capacitances of switches S1 and S4, and as a consequence, a zero-voltage soft switching in the next time segment.

At the time TC_P1, each of the control signals VS1 and VS4 is changed from the voltage level VL to the voltage level VH, such that each of the switches S1 and S4 is turned on. At this moment, in response to each of the switches S1 and S4 being turned on, each of the current signals IL and Im starts increasing, and following resonant trajectory. On the other side of transformer, each of the current signals I_S9, and I_S12 is conducted through body diodes of switches S9 and S12 as transformer TR is transferring energy.

During a period between time TC_P1 and TC_P2, each of the control signals VS1 and VS4 has the voltage level VH, such that each of the switches S1 and S4 remains turned on. Each of the control signals VS2, VS3, and VS5-VS8 has the voltage level VL, such that each of the switches S2, S3, and S5-S8 remains turned off. In response to each of the switches S1 and S4 being turned on, each of the current signals IL, Im, I_S9, and I_S12 remains increasing. The voltage of the capacitor CPN is commutated between the nodes N7 and N8.

At the time TC_P2, the control signal VS8 is changed from the voltage level VL to the voltage level VH, such that the switch S8 is turned on. This is pre-opening on of the switch S8 on the middle leg. The current does not flow through the switch S8 due to the switch S4 having lower impedance. Each of the control signals VS2, VS3, and VS5-VS7 has the voltage level VL, such that each of the switches S2, S3, and S5-S7 remains turned off. Each of the control signals VS1 and VS4 has the voltage level VH, such that each of the switches S1 and S4 remains turned on. In some embodiments, the middle leg refers to the middle part of the converter system 100, locating between the capacitors C_{PY}, C_{YN}, and C_{PN} and the switches S1-S4. The middle leg of the converter system 100 includes the switches S5-S8.

During a period between time TC_P2 and TC_P3, each of the control signals VS1, VS4, and VS8 has the voltage level VH, such that each of the switches S1, S4, and S8 remains turned on. Each of the control signals VS2, VS3, and VS5-VS7 has the voltage level VL, such that each of the switches S2, S3, and S5-S7 remains turned off. In response to each of the switches S1 and S4 being turned on, the current level of the current signal Im remains increasing. While the voltage of the capacitor CPN is still commutated between the nodes N7 and N8, and in response to each of the switches S1 and S4 being turned on, each of the current level of the current signal IL, I_S1, and I_S4 is still following the resonant trajectory, which is either increasing or already decreasing by this moment.

At the time TC_P3, the control signal VS4 is changed from the voltage level VH to the voltage level VL, such that the switch S4 is turned off. Each of the control signals VS1 and VS8 has the voltage level VH, such that each of the switches S1 and S8 remains turned on. At this moment, the middle leg is commutated through switch S8 and the body diode of the switch S7, and the capacitor C_{PY} is commutated between nodes N7 and N8.

During a period between time TC_P3 and TC_P4, each of the control signals VS1 and VS8 has the voltage level VH, such that each of the switches S1 and S8 remains turned on. Each of the control signals VS2-VS7 has the voltage level VL, such that each of the switches S2-S7 remains turned off. In response to each of the switches S1 and S8 being turned on, the voltage level applied to the resonant circuit is reduced to the voltage level of the capacitor C_{PY}. If the resonant circuit is operating at or higher than the resonant frequency of the switches S1-S8, the current levels of the current signals Im and IL would become equal to each other, and the power transferred to the transformer TR would be terminated. The currents flowing through the body diodes I_S9 and I_S12 would be decreased and remain zero. The conduction through the body diode of the switch S7 allows for the zero-voltage soft switching in the next timing.

At the time TC_P4, the control signal VS7 is changed from the voltage level VL to the voltage level VH, such that the switch S7 is turned on. Each of the voltage signals VS1 and VS8 has the voltage level VH, such that each of the switches S1 and S8 remains turned on. Each of the voltage signals VS2-VS6 has the voltage level VL, such that each of the switches S2-S6 remains turned off.

During a period between time TC_P4 and TC_P5, each of the voltage signals VS1, VS7, and VS8 has the voltage level VH, such that each of the switches S1, S7, and S8 remains turned on. Each of the voltage signals VS2-VS6 has the voltage level VL, such that each of the switches S2-S6 remains turned off. In response to the switch S7 being turned on the conductance loss is reduced. The voltage commutated to the resonant circuit remains to be the voltage of the capacitor C_{PY}.

At the time TC_P5, each of the voltage signals VS1, VS7, and VS8 is changed from the voltage level VH to the voltage level VL, such that each of the switches S1, S7, and S8 is turned off. Alternatively stated, each of the switches S1-S8 is turned off at the time TC_P5.

In some embodiments, the control of the switches S1-S8 during a period between the time TC_P5 and TC_P6 is similar to the period between the time TC_P0 and TC_P5. The differences between the period between the time TC_P5 and TC_P6 and the period between the time TC_P0 and TC_P5 is switching the voltage signals VS1, VS4, VS7, and VS8 by the voltage signals VS3, VS2, VS5, and VS6, respectively. As the result, the control of the switches S1-S8 after the time TC_P6 is not repeated herein for simplicity.

In some embodiments, a period between the time TC_P0 and TC_P5 is a half control cycle of the switches S1-S8. A period between the time TC_P0 and TC_P6 is a control cycle Ts of the switches S1-S8. Accordingly, the control of the switches S1-S8 is repeated multiple control cycle Ts, when the converter system 100 is operating.

In some embodiments, the control of the switches S1-S8 during a duty period DCP between time TC_P0 and TC_P4 is determined as the half control cycle multiplied by the duty ratio DPN. Alternatively stated, the duty period DCP is equal to the half control cycle multiplied by the duty ratio DPN.

In some embodiments, the control cycle Ts corresponds to the switch frequency FSW in FIG. 3. Specifically, the control cycle Ts is a reciprocal of the switch frequency FSW.

FIG. 6B is a timing diagram of the control signals VS1-VS8 controlling the switches S1-S8 of the converter system 100, illustrated in accordance with some embodiments of the present disclosure. FIG. 6A illustrates the variations of the voltage signals VS1-VS8 from time TC_N0 to time TC_N7. In some embodiments, FIG. 6B corresponds to the control of the switches S1-S8, when the polarity POL is negative and the converter system 100 is operated under the charge mode. In some embodiments, the control of the switches S1-S8 in the negative polarity is similar to the control of the switches S1-S8 in the positive polarity as shown in FIG. 6A. As the results, only the differences between FIG. 6A and FIG. 6B is discussed herein.

When the polarity POL is negative and the converter system 100 is operated under the charge mode, the principle of operation is analogous to the case with the positive polarity POL. The main difference of the operation between the negative polarity and the positive polarity is that each of the switches S1 and S3 is controlled by the duty ration DPN when the polarity POL is negative. On the contrary, each of the switches S2 and S4 is controlled by the duty ration DPN when the polarity POL is positive. Some other difference is that each of the switches S2 and S4 in negative polarity operates for half of the control cycle Ts, instead of the switches S1 and S3 in positive polarity. Moreover, the pre-opening on is performed by switches S5 and S7 in negative polarity, instead of switches S6 and S8 in positive polarity.

In some embodiments, a period between the time TC_N0 and TC_N5 is a half control cycle of the switches S1-S8. A period between the time TC_N0 and TC_N7 is similarly refers to the control cycle Ts of the switches S1-S8. Accordingly, the control of the switches S1-S8 is repeated multiple control cycle Ts, when the converter system 100 is operating.

In some embodiments, the control of the switches S1-S8 during a duty period DCN between time TC_N0 and TC_N4 is determined as the half control cycle multiplied by the duty ratio DPN. Alternatively stated, the duty period DCN is equal to the half control cycle multiplied by the duty ratio DPN. In some embodiments, the duty period DCN is different from the duty period DCP.

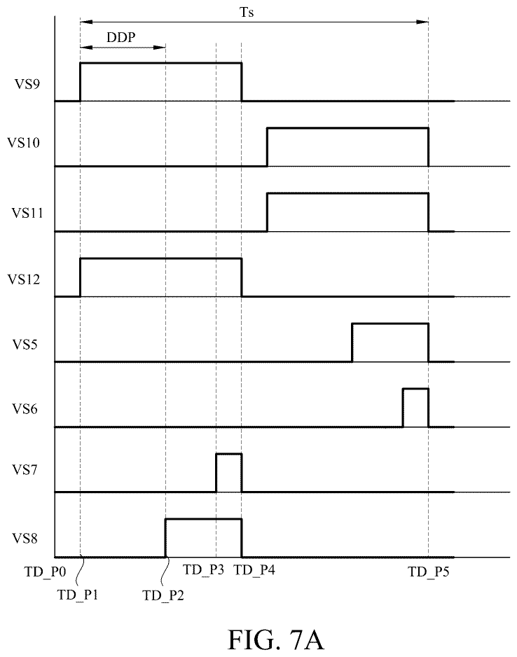

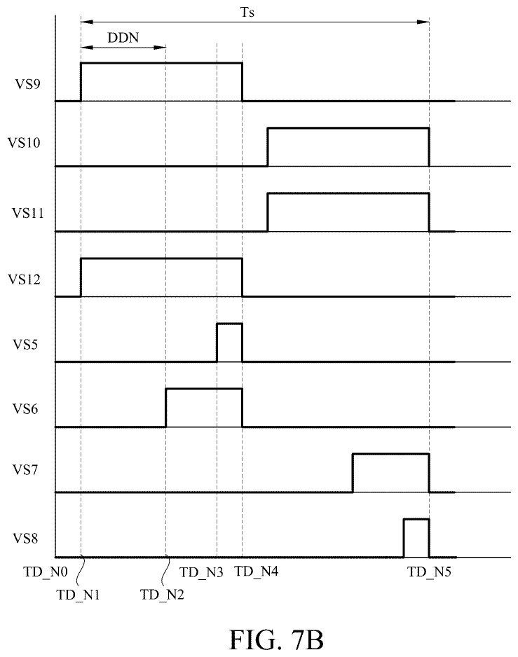

FIG. 7A is a timing diagram of the control signals VS5-VS12 controlling the switches S5-S12 of the converter system 100, illustrated in accordance with some embodiments of the present disclosure. FIG. 7A illustrates the variations of the voltage signals VS5-VS12 from time TD_P0 to time TD_P5. In some embodiments, FIG. 7A corresponds to the control of the switches S5-S12, when the polarity POL is positive and the converter system 100 is operated under the discharge mode.

Referring to FIG. 7A and FIG. 1, similar to the charge mode, each of the capacitors C_{PY}, C_{YN}, and C_{PN} is configured to provide the voltage filter that filters the commutation of the grid voltages, such as the rectified voltage, produced by the power circuit 110. Opposite to the charge mode, in discharge mode the current flow is redirected from battery to the grid. Alternatively stated, the current flows in a direction from the converter circuit 130 to the power circuit 110. The voltage of battery and output capacitor Co is applied to a CLLC filter on the DC side by commutation of the switches S9-S12. Energy flow of the CLLC filter in the discharge mode is opposite to the charge mode. In the discharge mode, the battery is generating current signals that are transformed through the transformer TR and modulated with converter circuit 130. The switch frequency FSW of switches S9-S12 is applied to regulate the DC side voltage, and the duty ratio DPN of the operation of bidirectional switches S5-S8 is applied to form the shape of the current signal IABC and the displacement of the phase voltage signal VABC.

During a period between time TD_P0 and TD_P1, each of the control signals VS5-VS12 has the voltage level VL, such that each of the switches S5-S12 is turned off. The magnetizing current signal Im is flowing in the same direction as it was a moment ago, and the output of capacitor was commutated such that the voltage between the nodes N10 and N11 was negative. In this case the magnetizing current Im is negative, forcing the body diodes of the switches S9 and S12 to be conducted, respectively. The conduction of the body diodes of the switches S9 and S12T allows the parasitic capacitances of switches S9 and S12 to discharge, and as a consequence the zero-voltage soft switching in the next time segment.

At the time TD_P1, each of the control signals VS9 and VS12 is changed from the voltage level VL to the voltage level VH, such that each of the switches S9 and S12 is turned on. Each of the control signals VS5-VS8 and VS10-VS11 has the voltage level VL, such that each of the switches S5-S8 and S10-S11 remains turned off.

At this moment, in response to each of the switches S9 and S12 being turned on, a positive voltage of the DC side capacitor is applied to the CLLC filter between the nodes N10 and N11, the current level of current signal IC2 starts increasing and flowing into dotted terminal of the TR, the voltage on the AC side of the transformer and the magnetizing current Im starts increasing. The body diodes of the switches S1 and S3 have not been conducted until the magnetizing inductance re-magnetizes and the resonant current signal IC2 on the DC side is higher than or equal to the magnetizing current Im. Alternatively stated, when the current signal IC2≥the magnetizing current Im, and the current signal IC2<the magnetizing current Im, the body diodes of the switches S4 and S2 remain being conducted.

During a period between time TD_P1 and TD_P2, each of the control signals VS9, and VS12 has the voltage level VH, such that each of the switches S9, and S12 remains turned on. Each of the control signals VS5-VS8 and VS10-VS11 has the voltage level VL, such that each of the switches S5-S8 and S10-S11 remains turned off. A positive voltage of the DC side capacitor Co is applied to the CLLC filter between the nodes N10 and N11. Each of the current level of each of the current signals IC2 and IL remains increasing. Initially when magnetizing current Im is higher than the current IC2, the body diodes of S2, S4 keep conducting. When resonant DC side current IC2 rises and higher than magnetizing current Im body diodes of switches S1, S3 start to conduct.

At the time TD_P2, the control signal VS8 is changed from the voltage level VL to the voltage level VH, such that the switch S8 is turned on. The switch S8 pre-opened and experiences hard switching. Switch S8 and body diode of the switch S7 form a path for the resonant current IL.

During a period between time TD_P2 and TD_P3, each of the control signals VS8-VS9 and VS12 has the voltage level VH, such that each of the switch S8-S9 and S12 remains turned on. Each of the control signals VS5-VS7 and VS10-VS11 has the voltage level VL, such that each of the switches S5-S7 and S10-S11 remains turned off. Each of the current level of the current signals IC2 and Im remains increasing. The resonant current IL is redirected to the middle leg through the switch S8 and the body diode of the switch S7. Modulation of this redirection is allowing for forming the current through inductors L_{f1}-L_{f3} of 110. The voltage difference between the nodes N10 and N11 remains the same as the voltage difference between two terminals of the capacitor Co.

At the time TD_P3, the control signal VS7 is changed from the voltage level VL to the voltage level VH, such that the switch S7 is turned on. The switch S7 is experiencing the soft switching due to its body diode is conducted prior to the time TD_P3.

During a period between time TD_P3 and TD_P4, each of the control signals VS7-VS9 and VS12 has the voltage level VH, such that each of the switches S7-S9 and S12 remains turned on. Each of the control signals VS5-VS6 and VS10-VS11 has the voltage level VL, such that each of the switches S5-S6 and S10-S11 remains turned off. The redirected resonant current is now flowing through the opened switches S7-S8 which reduces the conduction loss.

At the time TD_P4, each of the control signals VS7-VS9 and VS12 is changed from the voltage level VH to the voltage level VL, such that each of the switches S7-S9 and S12 is turned off. The next period is similar to the period previously described, which all the switches S5-S12 are off.

In some embodiments, the control of the switches S5-S12 during a period between the time TD_P4 and TD_P5 is similar to the period between the time TD_P0 and TD_P4. Due to a negative voltage being applied between the nodes N10 and N11, the currents are decreasing.

In some embodiments, a period between the time TD_P0 and TD_P4 is a half control cycle of the switches S5-S12. A period between the time TD_P0 and TD_P5 is similarly refers to the control cycle Ts. Accordingly, the control of the switches S5-S12 is repeated multiple control cycle Ts, when the converter system 100 is operating.

In some embodiments, the control of the switches S1-S8 during a duty period DDP between time TD_P0 and TD_P4 is determined as the half control cycle multiplied by the duty ratio DPN. Alternatively stated, the duty period DDP is equal to the half control cycle multiplied by the duty ratio DPN. In some embodiments, the duty period DDP is different from the periods DCP and DCN.

FIG. 7B is a timing diagram of the control signals VS5-VS12 controlling the switches S5-S12 of the converter system 100, illustrated in accordance with some embodiments of the present disclosure. FIG. 7B illustrates the variations of the voltage signals VS5-VS12 from time TD_N0 to time TD_N7. In some embodiments, FIG. 7B corresponds to the control of the switches S5-S12, when the polarity POL is negative and the converter system 100 is operated under the discharge mode. The main difference between the positive and negative plurality POL is the sequence of the pre-opening. In negative plurality POL, the switches S8 and S5 are pre-opened with hard switching and the switches S6 and S7 are turned on with soft switching later. As previously disclosed for the positive plurality POL, the switches S5 and S7 are pre-opened and the switches S8 and S6 are turned on with soft switching later. Other switches S9-S12 are operated in the same way with the embodiment of FIG. 7A. Processes of voltage and current flows are analogous in both cases.

FIG. 8 is a table 800 of logic values of the control signals VSR1-VSR12 of the rectifier circuit 110, illustrated in accordance with some embodiments of the present disclosure. As illustratively shown in FIG. 8, the table 800 illustrates the logic values of the control signals VSR1-VSR12 corresponds to each of conditions COND1-COND3.

Referring to FIG. 8 and FIG. 2, the selector 131 is configured to receive each of the phase voltage signals VA, VB, and VC, and generate the condition signals COND1-COND3. Then, the selector 131 performs a logic operation to each of the condition signals COND1-COND3 to determine the logic values of the control signals VSR1-VSR12. When each of the logic values of the control signals VSR1-VSR12 is determined, the selector 131 is further configured to control each of the switches SR1-SR12 according to the table 800.

Specifically, the selector 131 generates each of the condition signals COND1-COND3 according to the voltage levels of the phase voltage signals VA, VB, and VC. When the voltage level of the phase voltage signal VA is higher than the voltage level of the phase voltage signal VC, the condition signal COND1 has the logic value “1”. When the voltage level of the phase voltage signal VA is lower than the voltage level of the phase voltage signal VC, the condition signal COND1 has the logic value “0”. When the voltage level of the phase voltage signal VA is higher than the voltage level of the phase voltage signal VB, the condition signal COND2 has the logic value “1”. When the voltage level of the phase voltage signal VA is lower than the voltage level of the phase voltage signal VB, the condition signal COND2 has the logic value “0”. When the voltage level of the phase voltage signal VB is higher than the voltage level of the phase voltage signal VC, the condition signal COND3 has the logic value “1”. When the voltage level of the phase voltage signal VB is lower than the voltage level of the phase voltage signal VC, the condition signal COND3 has the logic value “0”.

In some embodiments, after the logic values of the condition signals COND1-COND3 are determined, the selector 131 controls each of the switches according to the logic operations to the condition signals COND1-COND3.

Specifically, the control of the switch SR1 is determined by performing an AND operation to the condition signals COND1 and COND2, that is COND1 AND COND2. The control of the switch SR2 is determined by performing a NOT operation and an AND operation to the condition signals COND1 and COND2, that is NOT(COND1) AND NOT(COND2). The control of the switch SR3 is determined by performing a NOT operation to the condition signal COND2 and an AND operation to the condition signals COND3 and COND2, that is COND3 AND NOT(COND2). The control of the switch SR4 is determined by performing a NOT operation to the condition signal COND3 and an AND operation to the condition signals COND2 and COND3, that is NOT(COND3) AND COND2. The control of the switch SR5 is determined by performing a NOT operation and an AND operation to the condition signals COND1 and COND3, that is NOT(COND1) AND NOT(COND3). The control of the switch SR6 is determined by performing an AND operation to the condition signals COND1 and COND3, that is COND1 AND COND3. The control of each of the switches SR7 and SR8 is determined by performing an XOR operation to the condition signals COND1 and COND2, that is COND1 XOR COND2. The control of each of the switches SR9 and SR10 is determined by performing an XNOR operation to the condition signals COND3 and COND2, that is COND3 XNOR COND2. The control of each of the switches SR11 and SR12 is determined by performing an XOR operation to the condition signals COND1 and COND3, that is COND1 XOR COND3.

In some embodiments, when the logic operations of the condition signals COND1-COND3 is true, the corresponding control signal of the switches SR1-SR12 has the voltage value “1”. When the logic operations of the condition signals COND1-COND3 is false, the corresponding control signals VSR1-VSR12 of the switches SR1-SR12 has the voltage value “0”.

In some embodiments, when the control signals VSR1-VSR12 have a logic value “1”, the control signals VSR1-VSR12 have the voltage level VH. Relatively, when the control signals VSR1-VSR12 have a logic value “0”, the control signals VSR1-VSR12 have the voltage level VL.

As illustratively shown in FIG. 8, when each of the condition signals COND1-COND3 has the logic value “1”, each of the control signals VSR1, VSR6, VSR9, and VSR10 has the logic value “1”, such that each of the switches SR1, SR6, SR9, and SR10 is turned on. When each of the condition signals COND1-COND3 has the logic value “1”, each of the control signals VSR2-VSR5, VSR7-VSR8, and VSR11-VSR12 has the logic value “0”, such that each of the switches SR2-SR5, SR7-SR8, and SR11-SR12 is turned off.

In some embodiments, when each of the condition signals COND1 and COND3 has the logic value “1” and the condition signal COND2 has the logic value “0”, each of the control signals VSR3 and VSR6-VSR8 has the logic value “1”, such that each of the switches SR3 and SR6-SR8 is turned on. When each of the condition signals COND1 and COND3 has the logic value “1” and the condition signal COND2 has the logic value “0”, each of the control signals VSR1-VSR2, VSR4-VSR5, and VSR9-VSR12 has the logic value “0”, such that each of the switches SR1-SR2, SR4-SR5, and SR9-SR12 is turned off.

In some embodiments, when each of the condition signals COND1 and COND2 has the logic value “0” and the condition signal COND3 has the logic value “1”, each of the control signals VSR2-VSR3 and VSR11-VSR12 has the logic value “1”, such that each of the switches SR2-SR3 and SR11-SR12 is turned on. When each of the condition signals COND1 and COND2 has the logic value “0” and the condition signal COND3 has the logic value “1”, each of the control signals VSR1 and VSR4-VSR10 has the logic value “0”, such that each of the switches SR1 and SR4-SR10 is turned off.

In some embodiments, when each of the condition signals COND1-COND3 has the logic value “0”, each of the control signals VSR2, VSR5, VSR9, and VSR10 has the logic value “1”, such that each of the switches SR2, SR5, SR9, and SR10 is turned on. When each of the condition signals COND1-COND3 has the logic value “0”, each of the control signals VSR1, VSR3-VSR4, VSR6-VSR8, and VSR11-VSR12 has the logic value “0”, such that each of the switches SR1, SR3-SR4, SR6-SR8, and SR11-SR12 is turned off.

In some embodiments, when each of the condition signals COND1 and COND3 has the logic value “0” and the condition signal COND2 has the logic value “1”, each of the control signals VSR4-VSR5 and VSR7-VSR8 has the logic value “1”, such that each of the switches SR4-SR5 and SR7-SR8 is turned on. When each of the condition signals COND1 and COND3 has the logic value “0” and the condition signal COND2 has the logic value “1”, each of the control signals VSR1-VSR3, VSR6, and VSR9-VSR12 has the logic value “0”, such that each of the switches SR1-SR3, SR6, and SR9-SR12 is turned off.

In some embodiments, when each of the condition signals COND1 and COND2 has the logic value “1” and the condition signal COND3 has the logic value “0”, each of the control signals VSR1, VSR4 and VSR11-VSR12 has the logic value “1”, such that each of the switches SR1, SR4 and SR11-SR12 is turned on. When each of the condition signals COND1 and COND2 has the logic value “1” and the condition signal COND3 has the logic value “0”, each of the control signals VSR2-VSR3 and VSR5-VSR10 has the logic value “0”, such that each of the switches SR2-SR3 and SR5-SR10 is turned off.

In some embodiments, each of the switches SR1-SR12 is controlled by the selector 131 in FIG. 2, and each of the switches S1-S12 is controlled by the selector 136 in FIG. 2. Alternatively stated, the control of each of the switches SR1-SR12 is independent to the control of each of the switches S1-S12.

Although the present disclosure has been described in considerable detail with reference to certain embodiments thereof, other embodiments are possible. Therefore, the spirit and scope of the appended claims should not be limited to the description of the embodiments contained in the present disclosure.

It will be apparent to those skilled in the art that various modifications and variations can be made to the structure of the present disclosure without departing from the scope or spirit of the disclosure. In view of the foregoing, it is intended that the present disclosure cover modifications and variations of the present disclosure provided they fall within the scope of the following claims.

What is claimed is:

1. A bidirectional AC-DC converter, comprising:
a plurality of inductors coupled to a plurality of power sources respectively;
a rectifier circuit comprising a plurality of first switches and coupled to the plurality of inductors;
a converter circuit comprising a plurality of second switches and coupled to the rectifier circuit; and
a first controller configured to provide a plurality of first control signals and a plurality of second control signals to control the plurality of first switches and the plurality of second switches respectively;
wherein the plurality of power sources is configured to provide a plurality of phase voltage signals and a plurality of current signals to the rectifier circuit, and
when converting the plurality of current signals from DC form to AC form during a discharge mode, the first controller provides the plurality of first control signals and the plurality of second control signals according to the plurality of phase voltage signals, the plurality of current signals, and a reference phase parameter.

2. The bidirectional AC-DC converter of claim 1, wherein the converter circuit further comprises:
a transformer comprising an AC side and a DC side;
a first capacitor coupled to the AC side and a first part of the plurality of second switches;
a second capacitor coupled the DC side and a second part of the plurality of second switches; and
an inductor coupled to the first capacitor and the transformer.

3. The bidirectional AC-DC converter of claim 1, wherein the first controller is further configured to:
determine a polarity of the converter circuit according to the plurality of current signals, and
determine a control cycle and a duty ratio of the converter circuit according to each of the plurality of current signals and a reference phase parameter to generate the plurality of second control signals.

4. The bidirectional AC-DC converter of claim 3, wherein during the discharge mode, each of a first switch of the plurality of second switches, a second switch of the plurality of second switches, a third switch of the plurality of second switches, and a fourth switch of the plurality of second switches is turned off.

5. The bidirectional AC-DC converter of claim 1, wherein when converting the plurality of current signals from AC form to DC form during a charge mode, the controller is further configured to control each of the plurality of first switches according to each of a first condition signal, a second condition signal, and a third condition signal,
when a first phase voltage signal of the plurality of phase voltage signals is higher than a second phase voltage signal of the plurality of phase voltage signals, the first condition signal has a first logic value,
when the first phase voltage signal is lower than the second phase voltage signal, the first condition signal has a second logic value,
when the first phase voltage signal is higher than a third phase voltage signal of the plurality of phase voltage signals, the second condition signal has the first logic value,
when the first phase voltage signal is lower than the third phase voltage signal, the second condition signal has the second logic value,
when the third phase voltage signal is higher than the second phase voltage signal, the third condition signal has the first logic value, and
when the third phase voltage signal is lower than the second phase voltage signal, the third condition signal has the second logic value.

6. The bidirectional AC-DC converter of claim 5, wherein during the charge mode, each of a fifth switch of the plurality of second switches, a sixth switch of the plurality of second switches, a seventh switch of the plurality of second switches, and an eighth switch of the plurality of second switches is turned off.

7. The bidirectional AC-DC converter of claim 5, wherein
when each of the first condition signal, the second condition signal, and the third condition signal has the first logic value, each of a first switch, a second switch, a third switch, and a fourth switch of the plurality of first switches is turned on,
when each of the first condition signal, the second condition signal, and the third condition signal has the second logic value, each of the third switch, the fourth switch, a fifth switch, and a sixth switch of the plurality of first switches is turned on,
when each of the first condition signal and the third condition signal has the first logic value, and the second condition signal has the second logic value, each of the second switch, a seventh switch, an eighth switch, and a ninth switch of the plurality of first switches is turned on,
when each of the first condition signal and the second condition signal has the second logic value, and the third condition signal has the first logic value, each of the fifth switch, the seventh switch, a tenth switch, and an eleventh switch of the plurality of first switches is turned on,
when each of the first condition signal and the third condition signal has the second logic value, and the second condition signal has the first logic value, each of a twelfth switch, the sixth switch, the eighth switch, and the ninth switch of the plurality of first switches is turned on, and
when each of the first condition signal and the second condition signal has the first logic value, and the third condition signal has the second logic value, each of the fourth switch, the tenth switch, the eleventh switch, and the twelfth switch of the plurality of first switches is turned on.

8. A method, comprising:
calculating a polarity of a converter system according to a plurality of current signals;
calculating a control cycle and a duty ratio of the converter system according to each of the plurality of current signals and a reference phase parameter; and
controlling a plurality of switches of the converter system according to each of the polarity, the control cycle and the duty ratio,
wherein when the converter system is under a charge mode, performing the following operations:
when the polarity is positive, turning on a first switch and a second switch of the plurality of switches, and turning off a third switch and a fourth switch of the plurality of switches, and
after each of the first switch and the second switch is turned on, turning off the second switch before the first switch is turned off.

9. The method of claim 8, further comprising:
when the converter system is under a discharge mode, performing the following operations:
when the polarity is positive, turning on a fifth switch and a sixth switch of the plurality of switches, and turning off a seventh switch and an eighth switch of the plurality of switches.

10. The method of claim 9, further comprising:
when the polarity is positive, turning on a ninth switch and a tenth switch of the plurality of switches; and
when each of the ninth switch and the tenth switch is turned off, turning on each of an eleventh switch and a twelfth switch.

11. The method of claim 10, wherein
the tenth switch is turned on after a duty period when each of fifth switch and the sixth switch is turned on, and
the eleventh switch is turned on before the twelfth switch is turned on.

12. The method of claim 11, wherein when the converter system is under a discharge mode, further comprising:
when the polarity is negative, turning on each of the fifth switch, the sixth switch, the eleventh switch, and the twelfth switch, and turning off the seventh switch and the eighth switch of the plurality of switches, and
when each of the eleventh switch and the twelfth switch is turned off, turning on each of the ninth switch and the tenth switch.

13. The method of claim 12, wherein
the twelfth switch is turned on after the duty period when each of the fifth switch and the sixth switch is turned off, and
the ninth switch is turned on before the tenth switch is turned on.

14. The method of claim 13, wherein
the duty period is equal to a half of the control cycle multiplied by the duty ratio, and
when the converter system is under the discharge mode, each of the first switch, the second switch, the third switch, and the fourth switch is turned off.

15. A converter system, comprising:
a plurality of power sources coupled to a plurality of inductors, respectively, the plurality of power sources configured to provide a plurality of phase voltage signals and a plurality of current signals;
a rectifier circuit coupled to the plurality of inductors;
a converter circuit comprising a plurality of first switches, a first capacitor and a second capacitor, each of the first capacitor and the second capacitor coupled to the rectifier circuit; and
a first controller configured to calculate a plurality of reference current signals, a plurality of domain current signals, and a plurality of domain reference current signals according to the plurality of phase voltage signals, the plurality of current signals, and a reference phase parameter.

16. The converter system of claim 15, further comprising:
a phase-locked loop configured to perform a phase lock operation to the plurality of voltage signals and generate a plurality of voltage phase parameters;
a first calculator configured to calculate the plurality of domain current signals and a plurality of domain phase parameters according to each of the plurality of current signals, the plurality of phase voltage signals, and the plurality of voltage phase parameters; and
a second calculator configured to calculate each of the plurality of reference current signals and the plurality of domain reference current signals.

17. The converter system of claim 16, further comprising:
a second controller configured to calculate a switch frequency and a duty ratio according to each of the plurality of domain current signals and the plurality of domain reference current signals; and
a first selector configured to control the plurality of first switches according to each of the plurality of reference current signals, the switch frequency, and the duty ratio.

18. The converter system of claim 15, wherein
the rectifier circuit is configured to control a plurality of second switches by performing a logic operation to the plurality of phase voltage signals,
when a first phase voltage signal of the plurality of phase voltage signals is higher than a second phase voltage signal of the plurality of phase voltage signals, a first condition signal has a first logic value,
when the first phase voltage signal is lower than the second phase voltage signal, the first condition signal has a second logic value,
when the first phase voltage signal is higher than a third phase voltage signal of the plurality of phase voltage signals, a second condition signal has the first logic value,
when the first phase voltage signal is lower than the third phase voltage signal, the second condition signal has the second logic value,
when the third phase voltage signal is higher than the second phase voltage signal, a third condition signal has the first logic value,
when the third phase voltage signal is lower than the second phase voltage signal, the third condition signal has the second logic value, and
the first logic value is different from the second logic value.

19. The converter system of claim 18, wherein
when each of the first condition signal, the second condition signal, and the third condition signal has the first logic value, each of a first switch, a second switch, a third switch, and a fourth switch of the plurality of second switches is turned on,
when each of the first condition signal, the second condition signal, and the third condition signal has the second logic value, each of the third switch, the fourth switch, a fifth switch, and a sixth switch of the plurality of second switches is turned on, and
when each of the first condition signal and the third condition signal has the first logic value, and the second condition signal has the second logic value, each of the second switch, a seventh switch, an eighth switch, and a ninth switch of the plurality of second switches is turned on.

20. The converter system of claim 19, wherein
when each of the first condition signal and the second condition signal has the second logic value, and the third condition signal has the first logic value, each of the fifth switch, the seventh switch, a tenth switch, and an eleventh switch of the plurality of second switches is turned on,
when each of the first condition signal and the third condition signal has the second logic value, and the second condition signal has the first logic value, each of a twelfth switch, the sixth switch, the eighth switch, and the ninth switch of the plurality of second switches is turned on, and
when each of the first condition signal and the second condition signal has the first logic value, and the third condition signal has the second logic value, each of the fourth switch, the tenth switch, the eleventh switch, and the twelfth switch of the plurality of second switches is turned on.
